(19) United States
(12) Patent Application Publication
(10) Pub. No.: US 2012/0066930 A1
(43) Pub. Date: Mar. 22, 2012

(54) FOOTWEAR COMPRISING A TWO-PIECES MOVABLE AND PIVOTING STRAP SYSTEM, AND, PROCESS FOR ITS MANUFACTURING AND/OR ASSEMBLY

(75) Inventor: Edson Matsuo, Porto Alegre (BR)

(73) Assignee: Grendene S/A, Sobral (BR)

(21) Appl. No.: 13/210,469

(22) Filed: Aug. 16, 2011

(30) Foreign Application Priority Data
Aug. 16, 2010 (BR) PI 1003015-8

(51) Int. Cl. A43B 3/12; B29D 35/00

(52) U.S. Cl. 36/11.5; 12/142 S

(57) ABSTRACT

Footwear and a process for manufacturing footwear, the footwear having a two-piece movable and pivoting strap system, the straps being adaptable to any width or shape of the feet, with at least one outer strap having an injection molded securing member having a non apparent pipette that fits in the sole of the footwear, at least one other strap having at least one coupling aperture to the securing member of the other strap.

### STATEMENT OF RELATED APPLICATIONS

This patent application claims the benefit under 35 USC 119 of Brazilian Patent Application No. PI 1003015-8 having a filing date of 16 Aug. 2010.

### BRIEF SUMMARY OF THE INVENTION

1. Technical Field

The present invention relates to the field of footwear engineering. More specifically, this invention relates to footwear comprising a two-piece movable and pivoting strap system, said straps being adaptable to any width/shape of the feet. The present invention also relates a process for manufacturing the footwear.

2. Prior Art

The development of technical solutions in footwear engineering is one subject of intense interest, both to circumvent the known limitations of industrial processes, and to provide improvements to the users.

Some prior art patent documents describe footwear including moldable and pivoting straps having clamping devices in the side straps of slippers using tips. Several prior art references that do not anticipate the invention or even suggest it, are listed below.

Brazilian patent document BR/MU8701515-3 describes an article of footwear that can be a clog, sandal, slipper or similar, which enables the exchange of the strap(s), that composes the vamp, to be fixed at front and lateral intermediate projections, all having one or more push buttons providing an easy procedure of exchanging the strap and also securely clamping the strap on the footwear, thereby enabling a range of colors, models and styles of the strap(s) and the footwear. The present invention differs from this document by presenting an article of footwear comprising a two-piece movable and pivoting strap system adaptable to any width/shape of the feet.

Brazilian patent document MU 8701510-2 describes an article of footwear with Y-shape straps that has a clamping device for accessories, having feasibility of removing and exchanging the decorative accessory that is applied in the outer portion of its strap. The clamping device is, more precisely, a Velcro® brand fastener element that is bonded to the strap through a vulcanization process by use of adhesive agent in the rubber of the strap. The present invention differs from this document by presenting an article of footwear comprising a two-piece movable and pivoting strap system, in which the straps themselves can be exchanged, being each strap of the same or different color, and may be adapted to different feet of each user, without using Velcro® brand fasteners.

International Patent Publication WO 2010/005949 describes a shoe with an interchangeable strap system that is adaptable to the foot of the user. The strap is attached to the sole in different ways, and may have a U- or Y-shape. The present invention differs from this document by presenting an article of footwear that has an outer strap with an injection molded securing member in the external strap, and an internal strap which has at least one coupling aperture that may be coupled to the securing member of the external strap, so that straps are pivoting and adapted to the shape of the foot of the user.

US Patent Publication No. US 2002/0078600 describes an article of footwear that has a sole, said sole having a first sidewall and a second sidewall that are spaced apart and extend between the upper and lower surfaces. In the middle portion of the spacing between the upper and lower surfaces fits a strip that crosses the sole and adapts to the foot of the user through the junction of the opposite ends of said strap. The present invention differs from this document by presenting pivoting interchangeable straps in Y-shape that are fixed to the sole through pipettes.

US Patent Publication No. US 2007/0266506 describes an article of footwear with interchangeable straps, said straps being attached by fasteners that are on the sides of the sole of the footwear. The present invention differs from this document by presenting an article of footwear with interchangeable pivoting straps that attach to the sole of the footwear through pipettes that are fitted on the sole of the footwear.

US Patent Publication No. US 2005/0066550 describes an article of footwear for females that has a sole and a base strap which is fixed to the sole of the footwear. The base strap extends to opposite sides of the footwear and extends around the foot of the user. The cover straps are removably connectable to the base straps and come in various colors, materials, shapes and patterns of decorative surface, to provide different styles and appearances, allowing that the same article of footwear can be used with many different outfits. The present invention differs from this document by presenting an article of footwear that has Y-shape straps in which the strap system moves around to adapt to different types of feet and the straps themselves are interchangeable to provide greater versatility in appearance to the footwear.

It is clear from the available literature that there are no documents suggesting or anticipating the inventive concept of the present invention, which provides various improvements to products and similar processes of the prior art.

### BRIEF SUMMARY OF THE INVENTION

The inventive concept common to several objects of the invention is the use of a strap system that fits in a simple way to different types/formats of foot, being efficient, inexpensive, and providing advantages both in the footwear and in the process for manufacturing/assembly of the footwear. The footwear straps of this invention comprise means for coupling the strap system to the sole, by fitting to the sole, a fitting-type projection present as an integral part of the strap system.

In a preferred aspect, the present invention provides a strap system comprising two pivoting straps to suit to different types/formats of foot. Preferably, the strap system is an ABS plastic or rubber strap with a securing member which has a pipette(s) on it end that fit(s) on the sole of the footwear of the present invention.

In another preferred aspect, the ends of the straps have pipettes that form the ends of the straps and comprise a circular cross-section followed by a larger diameter cylindrical head. The said fit of the pipette can be subsequently incorporated into the sole.

In another preferred aspect, the straps of the footwear of the present invention are removable, providing, therefore, different combinations of colors, textures and/or models, so that the footwear have different appearances, materials, and decorative surface patterns, to provide different styles or features.

In another preferred aspect, the present invention provides an article of footwear whose region containing the strap system comprises at least two mobile pivoting straps comprising:
(i) at least one outer strap including an injection molded securing member having a non apparent pipette that fits in the sole of the footwear;
(ii) at least one strap provided with at least one coupling aperture to the securing member of the other strap; and
(iii) both straps having pipettes in the posterior ends that connect conventionally into apertures, that fits in the sole of the footwear.

In another aspect, the present invention provides a strap system having a two-piece mobile and pivoting strap adaptable to any foot width of a footwear, slipper or sandal.

In another preferred aspect, the profile of pipettes that forms the end of the straps comprises a circular cross-section followed by a larger diameter cylindrical head.

In another preferred aspect, the straps of the footwear of the present invention are made of plastic or rubber.

In another preferred aspect, the invention is a process for manufacturing footwear comprising:
(i) a step of producing a footwear comprising a two-piece movable and pivoting strap system; and
(ii) a step of producing a sole to which the movable and pivoting straps fits.

The process of the invention may further comprise a step of fixing the strap system to the sole. Alternatively, this can be done by the user, especially when the footwear is presented as a combination of such components, such as more than one fixable strap system that can be affixed to the sole or vice-versa.

These and other objects of the invention will be immediately appreciated by those of ordinary skill in the art, and for companies with interests in the segment, and will be described in sufficient detail to be reproduced in the following description.

### BRIEF DESCRIPTION OF THE DRAWINGS

FIG. 1 shows a perspective view of a preferred embodiment of the present invention, wherein: (11) represents the sole, (12) inner strap, (13) outer strap, (14) securing member, said securing member being molded injected into the outer strap.

FIG. 2 shows a top view of a preferred embodiment of the present invention, wherein (21) represents the inner strap, (22) the outer strap.

FIG. 3 shows the straps of a preferred embodiment of the footwear of the present invention, wherein: (31) represents the inner strap, that attaches to the outer strap (32) of the strap system, the outer strap including a securing member (33) with a pipette.

FIG. 4 shows the straps of one preferred embodiment of the footwear of the present invention, wherein: (41) represents the inner strap, which is provided with an aperture (44) for the coupling of said inner strap (41) to the outer strap (42), said outer strap including a securing member (43) that is fixed on the sole of the footwear of the present invention.

FIG. 5 shows a side view of the straps in a preferred embodiment of footwear of the present invention, wherein (52) represents the inner strap, (51) represents the outer strap which has a securing member (53) having a pipette (54) with a larger diameter cylindrical head, the securing member being integrated to the outer strap.

FIG. 6 shows the outer (61) and inner strap (62) of a preferred embodiment of the footwear, said inner strap having an aperture (63) for coupling to the securing member (64) of outer strap.

### DETAILED DESCRIPTION OF PREFERRED EMBODIMENTS

The inventive concept common to the objects of the invention is the use of a strap system that adapts to different types/formats of foot in a simple, efficient and inexpensive way, providing advantages both in the footwear and in the process for manufacturing/assembly of the footwear. The straps of the footwear of the invention comprise fixing means from the strap system to the sole, by introducing, on the sole, a projection-type fitting present as an integral part of the strap system.

For purposes of the present invention, the terms “fixings means” or “snap-on fixing” refers to a means of fixing of the strap system to the sole of the footwear, said fixing mean being at the top of the sole of the footwear.

For purposes of the present invention, the term “fitting device” refers to a cylindrical head of diameter greater than the base, said cylinder head which is inserted into an inner projection of the sole of the footwear.

In one aspect, therefore, an object of the invention is to provide a strap system comprising two pivoting straps to suit different types/formats of foot. Preferably, the strap system is an ABS plastic strap or rubber with a securing member which has pipettes in its ends that fit into the sole of the footwear of the present invention.

In a preferred aspect, the ends of the straps have pipettes that form the ends of the straps and comprise a circular cross-section followed by a larger diameter cylindrical head. The fit of the pipette can be subsequently incorporated into the sole.

In a preferred aspect, the straps of the footwear of the present invention are removable, providing therefore a combination of different colors, textures and/or models, so that the footwear can have different appearances, materials, and decorative surface patterns to provide different styles.

In one aspect, the invention provides an article of footwear whose region containing the strap system comprises at least two mobile pivoting straps comprising:
(i) at least one outer strap comprising a securing member with a pipette that its not apparent that fits in the sole of the footwear;
(ii) at least a strap provided with at least one plug hole on the securing member of another strap; and
(iii) both straps having pipettes in the ends that connect conventionally into holes in the sole of footwear.

It is another object of the present invention to provide a strap system having a mobile and pivoting two-piece strap system that is adaptable to any format or foot width of a footwear-type slipper or sandal, and is adaptable to any format or foot width of an article of footwear, such as a slipper or sandal.

In a preferred aspect of the profile of pipettes that form the end of the straps, the profile comprises a circular cross-section followed by a larger diameter cylindrical head.

In a preferred aspect the straps of the footwear of the present invention are made of plastic or rubber.

In another aspect, the invention provides a process for manufacturing a footwear comprising:
(i) a step of producing an article of footwear comprising a two-piece strap system having mobile and pivoting straps and at least one position, and
(ii) a step of producing a sole to which the mobile and pivoting straps fits.

The process of the invention may further comprise a step of fixing the strap system to the sole. This step can be done inside the industrial unit or, alternatively, can be made by the user, especially when the footwear is presented as a combination of such components, such as providing more than one fixable strap system to the sole or vice versa.

For purposes of better understanding the invention, following will be made reference to preferred examples of the invention illustrated by the figures; provided, however, this description should not be interpreted as limiting the invention.

### Example 1

Strap system with mobile pivoting straps, footwear comprising the said strap system and sole and strap system combination.

Making reference to the figures, a preferred embodiment of the invention comprises a footwear with a sole (11), an inner strap (12, 21, 31, 41, 52, 62) which has a fitting hole (44, 62) to fix to an outer strap (12, 22, 32, 42, 51, 61), said outer strap with a securing member (14, 33, 43, 53) injected, which makes the fixing of the strap system to the soles (11) by a mean of connection, said securing member is part of the strap system material and comprises a circular cross-section followed by a cylindrical head (54) of greater diameter. Said cylinder head (54) is inserted into an internal projection of the sole of the footwear.

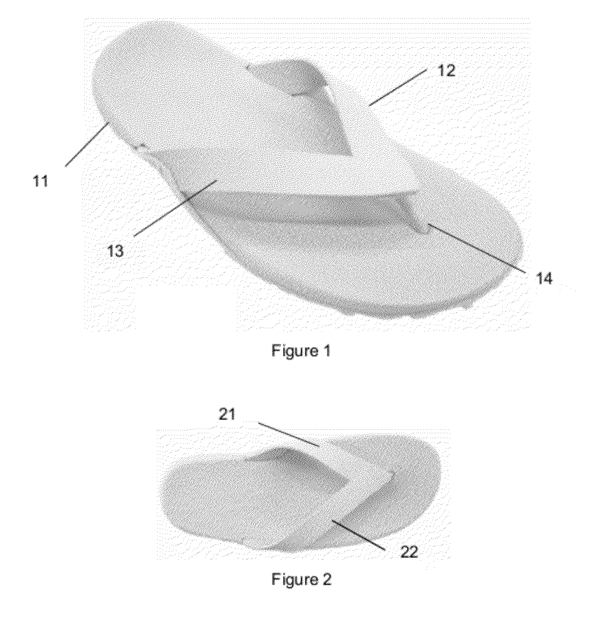

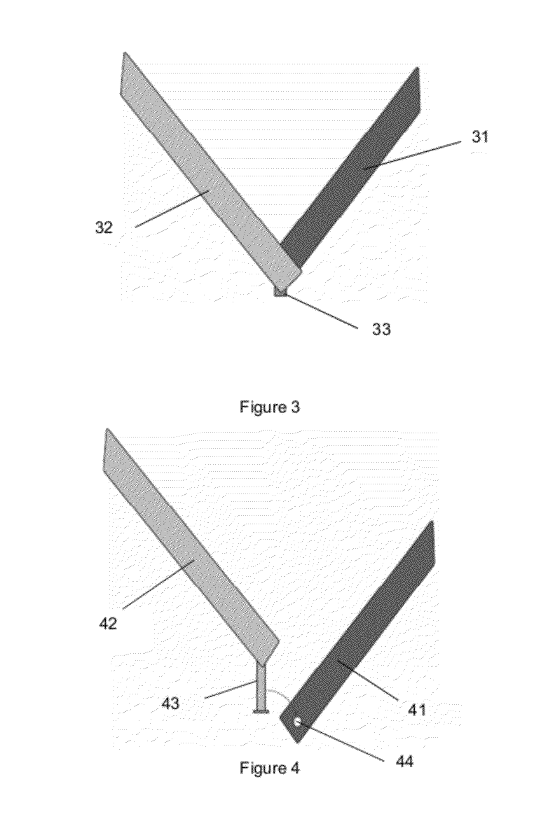

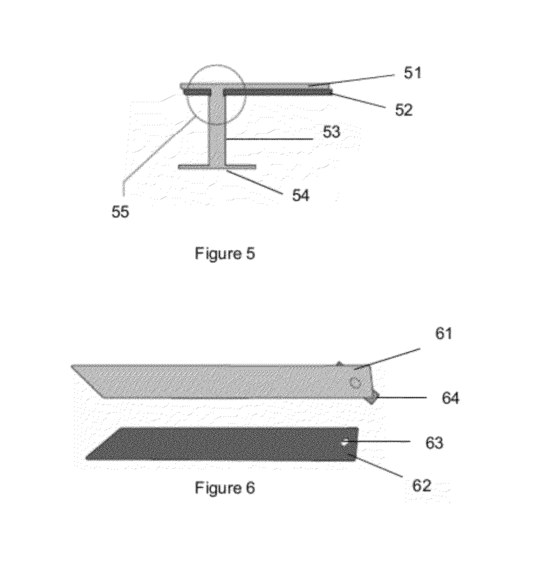

The fixing device of the invention eliminates the need for sophisticated operations or the use of machinery for fixing the strap system on the sole, providing several technical economical and operational advantages. FIG. 1 illustrates schematically such connection fitting device fixed at an inner projection of the sole and fitted so as not to come off.

As shown in FIG. 4, one of the straps may comprise a hole (44) to provide the pivoting moving of the other strap. In other preferred embodiments, the said strap can comprise two or more holes (44), providing thereby the accommodation to different sizes/formats of feet by the user and/or the manufacturer.

Those skilled in the art will value the knowledge shown, and will reproduce the invention in the manner shown and other variations within the scope of the attached claims.

1. Footwear of the slipper- or sandal-type comprising a strap system including at least two straps, wherein said straps are movable and pivoting relative to each other, in which:
(i) at least one strap comprises an injection molded securing member having a non apparent pipette that fits in the sole of the footwear; and
(ii) at least one strap comprises at least one coupling aperture to the securing member of the other strap.

2. The footwear according to claim 1, wherein said straps are made of plastic.

3. The footwear according to claim 1, wherein said straps are made of rubber.

4. The footwear according to claim 1, wherein said injection molded securing member and a coupling means of the strap system to the sole are a single part.

5. The footwear according to claim 1, wherein one of the at least two straps comprises at least two apertures.

6. A process for manufacturing footwear, comprising the steps of:
(i) producing a two piece movable and pivoting strap system;
(ii) producing a sole to which the movable and pivoting strap system fits; and
(iii) coupling one strap of the strap system to another strap of the strap system using at least one aperture present in one of the straps.

7. The process according to claim 8, further comprising the step of fixing at least one strap of the strap system to the sole.

8. The footwear according to claim 2, wherein said injection molded securing member and a coupling means of the strap system to the sole are a single part.

9. The footwear according to claim 3, wherein said injection molded securing member and a coupling means of the strap system to the sole are a single part.

10. The footwear according to claim 2, wherein one of the at least two straps comprises at least two apertures.

11. The footwear according to claim 3, wherein one of the at least two straps comprises at least two apertures.

12. The footwear according to claim 5, wherein said injection molded securing member and a coupling means of the strap system to the sole are a single part.

13. The footwear according to claim 10, wherein said injection molded securing member and a coupling means of the strap system to the sole are a single part.

14. The footwear according to claim 11, wherein said injection molded securing member and a coupling means of the strap system to the sole are a single part.
